(19) United States
(12) Patent Application Publication
(10) Pub. No.: US 2025/0001899 A1
(43) Pub. Date: Jan. 2, 2025

(54) SMART ELECTRIC CHARGING SCHEDULER FOR ELECTRIC VEHICLES

(71) Applicant: International Business Machines Corporation, Armonk, NY (US)

(72) Inventors: Siddhartha Sood, Ghaziabad (IN); Anil Laxman Palled, Pune (IN); Abhishek Jain, Baraut (IN); Adinarayana Haridas, Hyderabad (IN)

(21) Appl. No.: 18/344,469

(22) Filed: Jun. 29, 2023

(51) Int. Cl. B60L 53/67; B60L 53/12; B60L 53/62

(52) U.S. Cl. CPC B60L 53/67; B60L 53/12; B60L 53/62; B60L 2240/60; B60L 2240/80

(57) ABSTRACT

A system can comprise a memory that stores computer executable components, and a processor, operably coupled to the memory, that executes the computer executable components comprising: a scheduler component that schedules an electric charging time slot for a charging patch of a road for an electric vehicle based on an energy requirement of the electric vehicle and a destination arrival time requirement of the electric vehicle. In an embodiment, the scheduler component can schedule the electric charging time slot further based on passenger range anxiety. In an embodiment, the electric charging time slot can be adjusted based on a second energy requirement of a second electric vehicle.

### BACKGROUND

The subject disclosure relates to charging of electric vehicles, and more specifically, to scheduling charging slots for electric vehicles.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products in accordance with the present invention.

According to an embodiment, a system can comprise a memory that stores computer executable components; and a processor that executes the computer executable components stored in the memory. The computer executable components can comprise: a scheduler component that schedules an electric charging time slot on a charging patch of a road for an electric vehicle based on an energy requirement of the electric vehicle and a destination arrival time requirement of the electric vehicle.

According to another embodiment, a computer-implemented method can comprise receiving, by a system operably coupled to a processor, an energy requirement of an electric vehicle and a destination arrival time requirement of the electric vehicle, and scheduling, by the system, an electric charging time slot for a charging patch of a road for the electric vehicle driving on the road based on an energy requirement of the electric vehicle and a destination arrival time requirement of the electric vehicle.

In accordance with another embodiment, a computer program product facilitating scheduling charging for electric vehicles can comprise a computer readable storage medium having program instructions embodied therewith, the program instructions executable by a processor to cause the processor to receive an energy requirement of an electric vehicle and a destination arrival time requirement of the electric vehicle; and schedule an electric charging time slot for a charging patch of a road for the electric vehicle driving on the road based on an energy requirement of the electric vehicle and a destination arrival time requirement of the electric vehicle.

### DESCRIPTION OF THE DRAWINGS

FIG. 1 illustrates a block diagram of an example, non-limiting system that can facilitate scheduling charging for electric vehicles, in accordance with one or more embodiments described herein.

FIG. 2 illustrates a block diagram of an example, non-limiting system that can facilitate scheduling charging for electric vehicles, in accordance with one or more embodiments described herein.

FIG. 3 illustrates a diagram of an example, non-limiting roadway comprising electric charging lane, in accordance with one or more embodiments described herein.

FIG. 4A illustrates a diagram of an example, non-limiting electric vehicle and overhead charging rail, in accordance with one or more embodiments described herein.

FIG. 4B illustrates a diagram of an example, non-limiting electric vehicle and underlaying charging rail, in accordance with one or more embodiments described herein.

FIG. 4C illustrates a diagram of an example, non-limiting electric vehicle and side charging rail, in accordance with one or more embodiments described herein.

FIG. 5 illustrates a flow diagram of an example, non-limiting computer-implemented method for facilitating scheduling charging for electric vehicles, in accordance with one or more embodiments described herein.

FIG. 6 illustrates a flow diagram of an example, non-limiting computer-implemented method for facilitating scheduling charging for electric vehicles, in accordance with one or more embodiments described herein.

FIG. 7 illustrates a flow diagram of an example, non-limiting computer-implemented method for facilitating scheduling charging for electric vehicles, in accordance with one or more embodiments described herein.

FIG. 8 illustrates a flow diagram of an example, non-limiting computer-implemented method for facilitating scheduling charging for electric vehicles, in accordance with one or more embodiments described herein.

FIG. 9 illustrates a flow diagram of an example, non-limiting computer-implemented method for facilitating scheduling charging for electric vehicles, in accordance with one or more embodiments described herein.

FIG. 10 illustrates a block diagram of an example, computing environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

While electric vehicles (EVs) are increasing in popularity, due at least in part to their capacity to utilize power originating from sustainable energy sources, challenges remain in expanding their use. One challenge to further expansion of use of electric vehicles is the limited driving range per amount of time spent charging. Various options for EV charging allow for a range of charging efficiencies. For example, EVs can connect to a typical 120-volt AC household outlet, though the EVs often require overnight charging and offer a charging rate of approximately 2-5 miles of range per hour of charging time. Public charging stations may offer faster charging via a 240-volt AC power source and typically deliver approximately 10-30 miles of range per hour spent charging. Charging stations may also offer fast DC charging options that allow for even faster charging of an EV battery.

Wireless charging options are becoming available for EVs as well. Wireless charging mechanisms can charge a battery of an EV without a cable connection. A wireless charging apparatus can cause a dynamic power transfer to a battery of an EV equipped with an appropriate receiver. Some wireless charging apparatuses establish a wireless connection between itself and EV battery and generate an alternating magnetic field to induce an electric current within a coil of the receiver. Some wireless charging apparatuses establish a non-cabled physical connection and transfer energy by conductance. Like that of charging stations that utilize cabled connections, the efficiency of charging wireless charging mechanisms can vary substantially. Efficiency depends on the specific apparatus used, the quality of the EV battery, a speed of a vehicle, various environmental conditions, alignment and positioning of the vehicle, and other factors.

EV charging technologies that do not require a cable connection have facilitated the development of EV charging mechanisms that can be integrated with a road or parking area. For example, a wireless charging apparatus can be installed beneath the pavement or otherwise integrated with the surface of a parking space. The battery of an EV parked in the parking space can be charged without the EV needing to be plugged in. Wireless charging apparatuses can also be located beneath, to the side of, or above a road way or a designated lane of a roadway and can be configured to charge an EV while it is driving. For example, the wireless charging apparatus can be beneath or integrated with a road surface. For another example, the wireless charging apparatus can take the form of a rail extending alongside or above a road or lane. Depending on the capabilities of the wireless charging apparatus used and the EV, an EV driving on a charging road and receiving battery charge from a wireless charging mechanism may increase battery charge over the time spent on the road even though the vehicle is also expending energy by driving. Use of the charging road may also cause a battery of an EV to maintain its level of charge during the drive or decrease at a slower rate.

Passengers of an electric vehicle must ensure that the EV battery enables enough driving range to reach the passenger's destination or an available charging station at all times to prevent the EV battery from depleting during travel. This can make travel planning difficult, as there may be many different charging options along a driving route with varying availability for use (e.g., due to high traffic), energy capacity, and charging efficiency. For example, a traveler can be traveling to a destination requiring mileage that exceeds an EV's current driving range. The trip may take approximately 4 hours to complete with no stops for recharging, and the traveler may aim to arrive at the destination within 4.5 hours. It may be difficult for the traveler to determine where, when, and for how long the EV needs to be charged to reach the destination on time. The traveler may not be aware of the different locations and types of charging available along or near the driving route. The traveler is further unlikely to know exactly how long the EV would need to charge to reach a level of battery charge that would allow the traveler to reach the destination at the desired time. It can be difficult for the traveler to predict a required charging time due to vast inconsistencies in charging efficiency of different charging stations. Further, the charging options may have limited availability in space, time, or energy capacity, and so the traveler may find that some charging options are actually unavailable upon arrival.

It is likely that some EV travelers will develop range anxiety. Range anxiety can root from a worry that a battery of an electric vehicle will become depleted before the vehicle can reach its destination or an electric vehicle charging station. A passenger may worry about a need to keep track of how much driving range is available at a given time for a vehicle. The passenger may further worry about the need to locate charging stations near or along a driving route that will be available upon arrival. Additionally, the need to charge the battery of the electric vehicle may result in undesired stops in a long road trip. Stops may also be longer than desired because of the time needed to charge the electric vehicle at a parked charging station. These and other factors can make planning a trip in an electric vehicle stressful and difficult to plan.

While the implementation of charging roads or lanes may limit a number of and shorten necessary stops and provide additional options for charging, there may be scenarios where a charging lane of a charging road is not continuously available to an electric vehicle. Charging roads and charging lanes may be expensive and time-consuming to implement in many areas. For this reason, a road may have various patches of road having charging capabilities, or designated charging lanes that may also have charging patches, while the rest of the road does not have charging capabilities. For example, a four-lane highway may have one lane that is installed with a charging lane for one mile every five miles. Therefore, charging lanes on a road will have limited physical space and may have limited charging capacity (i.e., the charging lane can generate a certain amount of charge per hour). This is especially true in high traffic areas and/or times where it is highly desirable to be able to charge an EV while driving.

It is desirable for use of charging lanes and other charging options to be able to be booked in a schedule automatically. For automatic scheduling, a scheduler of an electric vehicle can communicate with a scheduler for one or more charging stations located along or near a driving route. The scheduler of the electric vehicle can further communicate with schedulers of other electric vehicles. The scheduler of the electric vehicle can schedule the electric vehicle based on the power needs of the vehicle. In an embodiment, the scheduler of the electric vehicle can schedule a charging time slot for the electric vehicle based in part on the power needs of other electric vehicles that it communicates with. In another embodiment, the scheduler can further schedule a charging time slot for the electric vehicle based in part on the circumstances or requirements of a local power grid. The ability to reserve a time slot for use of a charging lane or other charging option can case range anxiety for many electric vehicle passengers. By communicating with charging stations and other vehicles, electric vehicle charging schedulers can facilitate an optimized charging schedule. Such an optimized charging schedule can reduce the number of incidences of complete battery depletion for electric vehicles driving in an area as well as reduce power grid strain that could lead to local power outages or disruptions.

By way of overview, aspects of systems apparatuses or processes in accordance with the present invention can be implemented as machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however in various cases, that the one or more embodiments can be practiced without these specific details. As used herein, the term “entity” can refer to a machine, device, component, hardware, software, smart device and/or human.

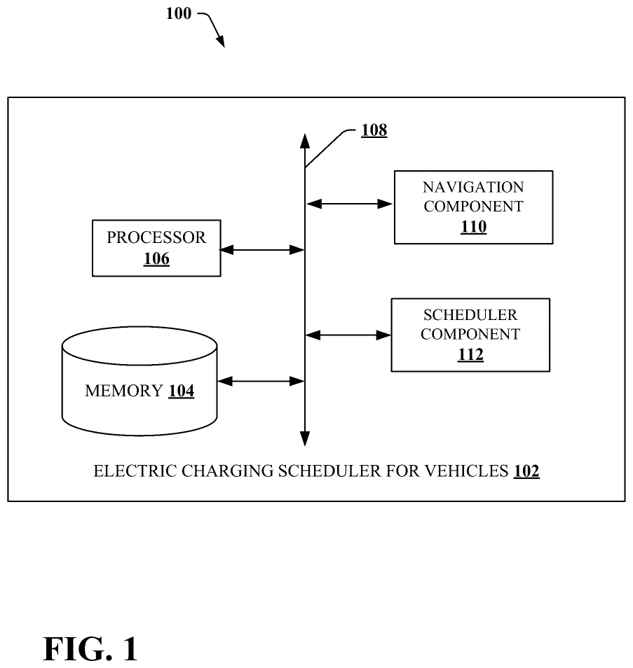

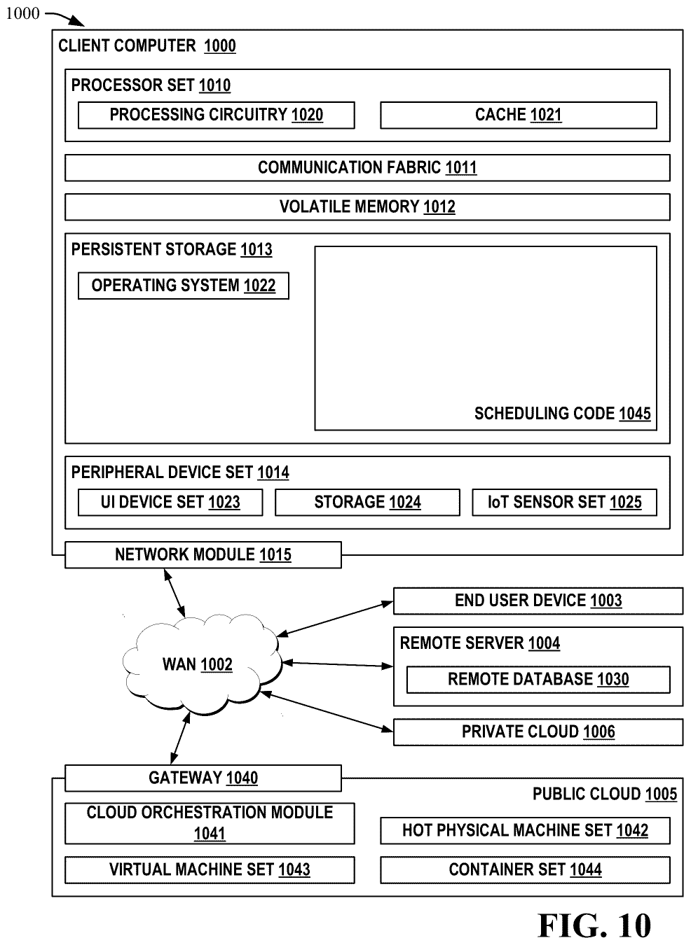

Further, the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting systems 100-400C as illustrated at FIGS. 1-4C, and/or systems thereof, can further comprise, be associated with and/or be coupled to one or more computer and/or computing-based elements described herein with reference to an operating environment, such as the operating environment 1000 illustrated at FIG. 10. In one or more described embodiments, computer and/or computing-based elements can be used in connection with implementing one or more of the systems, devices, components and/or computer-implemented operations shown and/or described in connection with FIGS. 1-4C and/or with other figures described herein.

FIG. 1 illustrates a block diagram of an example, non-limiting electric charging scheduler for vehicles system 102 that facilitates scheduling charging for electric vehicles in accordance with one or more embodiments described herein. As illustrated at FIG. 1, the electric charging scheduler for vehicles system 102 can comprise one or more components, such as a memory 104, processor 106, bus 108, navigation component 110 and/or scheduler component 112. Generally, electric charging scheduler for vehicles system 102 can facilitate scheduling charging for electric vehicles based on a variety of factors.

The scheduler component 112 can schedule an electric charging time slot for a charging patch of a road for an electric vehicle based on an energy requirement of the electric vehicle and a destination arrival time requirement of the electric vehicle. The navigation component 110 can access a driving route of an electric vehicle. For example, the driving route could be input by a passenger or other user. For another example, the driving route can be generated by a GPS based on a starting or current location and a destination input by a passenger or other user. The navigation component 110 can determine, based on the driving route, an energy requirement of an electric vehicle for the electric vehicle to reach its destination. Determining the energy requirement of an electric vehicle for the electric vehicle to reach its destination can comprise determining a distance between the EV's current location and the destination. Determining the energy requirement can further comprise determining one or more factors that can affect the driving range of the EV, such as traffic conditions, weather, and geography. Determining the energy requirement can further comprise determining a proportion of battery charge necessary to travel the determined distance accounting for the determined factors based on at least one of a predicted driving range determined by a system of the EV and historical driving ranges in various conditions. The navigation component 110 can further similarly determine the energy requirement of an electric vehicle for the electric vehicle to reach a next charging destination. The navigation component 110 can determine whether a current state of charge of an EV battery meets an energy requirement by comparing the state of charge and the calculated energy requirement. The navigation component 110 can determine an energy requirement of the electric vehicle based on the driving route and a predicted range for the electric vehicle for a level of battery charge. For example, a traveler's destination may be 90 miles away through light traffic. The route may take the traveler through 85 miles of highway driving and 5 miles of city driving. Based on the EV's mileage estimates, historical data detailing prior energy requirements in similar conditions, and the factors associated with the driving route, the navigation component may determine that the electric vehicle's energy requirement is 30% of battery capacity.

The navigation component 110 can further determine a destination arrival time requirement of the electric vehicle based on the driving route. The navigation component 110 can determine a destination arrival time requirement based on, for example, input from a passenger of the EV or a calendar or other schedule. Based on the destination arrival time requirement, the scheduler component 112 can determine an amount of time available for stationary charging and in-motion charging at a charging patch of a road. In an embodiment, in-motion charging at a charging patch of a road can be more efficient if the vehicle moves at a particular speed or range of speeds over the charging patch.

The scheduler component 112 can schedule an electric charging time slot for a charging patch of a road for an electric vehicle. The scheduler component 112 can schedule the time slot based on at least, for example, the energy requirement of the electric vehicle. The scheduler component 112 can schedule the time slot based on at least, for example, the destination arrival time requirement for the electric vehicle. The scheduler component 112 can schedule the time slot based on at least, for example, an expected arrival time of the electric vehicle at a charging station. The navigation component 110 can determine the expected arrival time based on, for example, the driving route, the speed of the vehicle, planned stops, and current and predicted traffic conditions. The scheduler component 112 can schedule the time slot based on at least, for example, expected charging opportunities along or near the driving route. The navigation component 110 can determine stationary charging stations and charging patches along the driving route and their locations. The scheduler component 112 can communicate with the stationary charging stations and the charging patches to determine their current and scheduled capacity and availability for charging.

In an embodiment, the scheduler component 112 can automatically schedule electric vehicles for charging time slots for a charging patch of a road or for a stationary charger. Use of a charging patch of a road can lead to an extended period of time between necessary stops at a stationary charger. The scheduler component 112 can schedule the time slot for an electric vehicle based on various factors. For example, the system can schedule the time slot based on requirements and circumstances of the EV and its passengers. The scheduling can be based on a driving route of the electric vehicle, and an associated energy and time requirement for the driving route. The scheduling can further be based on a current or predicted driving range of the electric vehicle, and the predicted driving range can be based on the battery's state of charge, historical driving patterns and accessory usage of the vehicle, and driving conditions such as weather, geography, and traffic. From the driving route and other factors, the system can determine an energy requirement of the electric vehicle and a destination arrival time requirement of the electric vehicle.

The scheduling by the scheduler component 112 can further be based on charging opportunities available along the driving route. The system can dynamically collect information related to the charging capacity of the charging opportunities. For example, the scheduler component 112 can communicate with various charging frameworks such as a parking intelligence framework of a city. The scheduler component 112 can receive monitoring information related to charging demand, availability, and grid limitations in an area. The received monitoring information may be based on management and optimization of power distribution over a city or other area to prevent grid overloads and voltage fluctuations. The scheduler component 112 can further request priority allocation of power for a scheduled charging time slot from a charging framework.

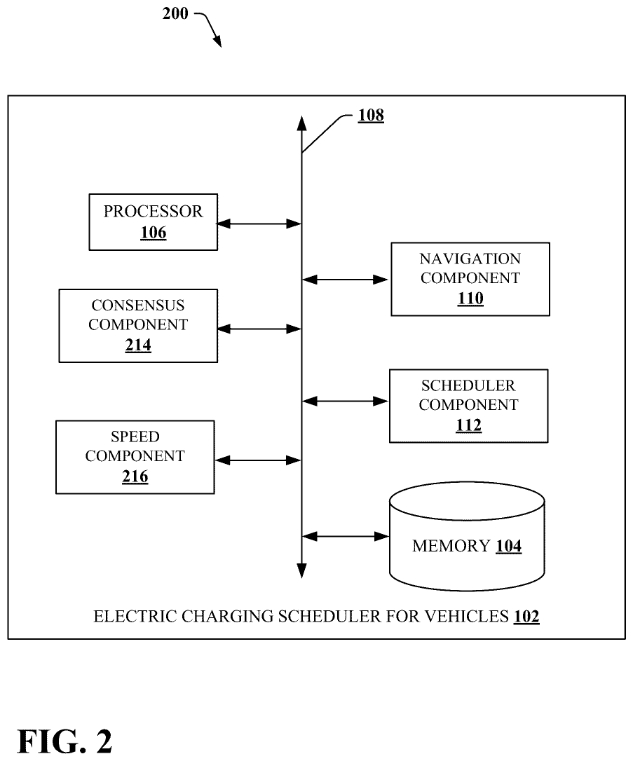

In an embodiment, the system can communicate with other electric vehicles on a road, within a defined area, and/or within a threshold distance of the electric vehicle. The scheduling by the scheduler component 112 can be based in part on one or more requirements or circumstances of the other electric vehicles. In an embodiment, the scheduled time of a charging slot can be adjusted for one or more electric vehicles based on communications from other electric vehicles. Further description can be found below with reference to FIG. 2.

In an embodiment, the scheduling of the scheduler component 112 can comprise determining, based on an energy requirement and a current state of charge, that an EV requires charging during a trip. The scheduling can further comprise determining a predicted arrival time or an arrival time window of the electric vehicle at one or more charging patches or stationary charging stations. The scheduling can further comprise communicating with a framework of the one or more charging patches or stationary charging stations to schedule the electric vehicle for a charging time slot. For example, the scheduler component 112 can send a scheduling request to a charging patch or stationary charging station for a particular time or time window and receive a confirmation or denial in return. In response to receiving a denial, the scheduling component 112 can communicate an alternative request to the same or a different charging patch or stationary charging station. For another example, the scheduler component 112 can receive available time slots associated with one or more charging patches or stationary charging stations and confirm one or more time slots as scheduled for the EV.

In an embodiment, the scheduler component 112 can schedule a time slot on a charging patch of road while the electric vehicle is driving on the road. In another embodiment, the scheduler component 112 can schedule a time slot on a charging patch of road prior to the vehicle driving on the road, such as when the vehicle is using stationary charging station, or prior to commencing the trip.

In an embodiment, the scheduler component 112 can schedule a time slot for a stationary charging station. The stationary charging station can be located within a threshold distance of the driving route. In an embodiment, the scheduler component 112 can schedule a time slot for a stationary charging station only when no charging patch will be available for the electric vehicle. In another embodiment, the scheduler component 112 can scheduler a time slot for a stationary charging station to supplement insufficient charging availability for charging patches along the driving route.

In an embodiment, the scheduler component 112 can schedule a time slot for an amount of time sufficient to charge the battery of the electric car enough to reach its next scheduled charging slot or next charging opportunity. The scheduling component 112 can determine a necessary amount of time to charge at a particular charging patch or stationary charging station based on an efficiency of the particular charging patch or stationary charging station and an energy requirement of the EV. For example, scheduler component 112 can schedule an electric vehicle for a charging slot for 20 minutes at a stationary charging station near the driving route. The 20-minute stationary charge may allow the electric vehicle to reach a charging patch further along the driving route at a time when the charging patch has availability. Scheduler component 112 can schedule the electric vehicle for the charging patch as well. This may limit the amount of time taken at a stop and allow the electric vehicle to reach its destination sooner.

In an embodiment, the scheduler component 112 can, prior to beginning a planned trip, recognize that the electric vehicle does not have enough range to complete the trip based on a current level of battery charge. The scheduler component 112 can, in response, identify stationary charging stations and charging lane stations available along or within a threshold distance of the planned driving route or the electric vehicle's current location. The scheduler component 112 can schedule a charging time slot for the electric vehicle at a stationary charging station or a charging patch based on an amount of time before the trip is scheduled to start and a level of traffic congestion expected at or within a threshold distance of the stationary charging stations and the charging patches. For example, if there is sufficient time before the trip is scheduled to start, the scheduler component 112 can schedule the electric vehicle at a stationary charging station. For another example, if there is sufficient time before the trip is scheduled to start, the scheduler component 112 can schedule the electric vehicle at a stationary charging station only if there is a high or moderate level of traffic in a defined area around a charging patch that the electric vehicle could reach along the planned driving route. For another example, if there is not sufficient time before a trip is scheduled to start, the scheduler component 112 can schedule a time slot in a charging patch that the electric vehicle could reach along the planned driving route, even if traffic congestion is predicted to be high. For another example, if there is sufficient time before the trip is scheduled to start, but predicted traffic congestion is low, the scheduler component 112 can schedule a time slot in a charging patch that the electric vehicle could reach along the planned driving route.

The various devices (e.g., system 100) and components (memory 104, processor 106, navigation component 110, scheduler component 112 and/or other components) of system 100 can be connected either directly or via one or more networks. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology.

FIG. 2 illustrates a block diagram of an example, non-limiting system 200 that facilitates scheduling charging for electric vehicles in accordance with one or more embodiments described herein. Repetitive description of like elements and/or processes employed in respective embodiments is omitted for sake of brevity. As indicated previously, description relative to an embodiment of FIG. 1 can be applicable to an embodiment of FIG. 2. Likewise, description relative to an embodiment of FIG. 2 can be applicable to an embodiment of FIG. 1.

The system 200 comprises a consensus component 214. The consensus component 214 can adjust the electric charging time slot of an electric vehicle (i.e., a first electric vehicle) based on a second energy requirement of a second electric vehicle. In an embodiment, the consensus component 214 can communicate with other electric vehicles on a road, within a defined area, or within a threshold distance of the electric vehicle. The consensus component 214 can coordinate with schedulers of one or more other electric vehicles. For example, the consensus component 214 can receive a second energy requirement of a second vehicle. The consensus component 214 can determine based on the energy requirement of the electric vehicle and the second energy requirement of the second vehicle whether the charging time slot should be adjusted.

For example, the electric vehicle can be driving on a road with charging patches. The electric vehicle can be scheduled for a charging time slot for an upcoming charging patch. The battery of the electric vehicle may exceed its energy requirement to reach the charging patch at the scheduled time slot. A second vehicle can be driving near the electric vehicle on the road. The second energy requirement of the second electric vehicle to reach its next charging time slot may exceed the charge of the battery of the second electric vehicle. The consensus component 214 can determine whether the level of battery charge of the electric vehicle would meet a new energy requirement if the electric charging time slot were to be adjusted to a later time. If the consensus component 214 determines this to be the case, the consensus component 214 can adjust the electric charging time slot of the electric vehicle to free the time slot for the second electric vehicle. In an embodiment, the electric vehicle can be already driving in the charging lane when the consensus component 214 adjusts the time slot. In an embodiment, the consensus component 214 can swap an electric charging time slot of the first electric vehicle for an electric charging time slot of the second electric vehicle.

The consensus component 214 can further determine whether a first electric vehicle possesses enough energy to reach a first charging patch at its electric charging time slot. Enough energy may be construed to represent a predetermined minimum amount of energy to reach a calculated or predetermined destination. In response to a determination that the first electric vehicle does not possess enough energy to reach the first charging patch at the electric charging slot, the consensus component 214 can determine whether a second electric vehicle currently driving in a second charging patch possesses enough energy to reach a future electric charging slot of the second electric vehicle based on a communication with the second electric vehicle. If the second electric vehicle currently driving in a second charging patch does possess enough energy to reach a future electric charging slot of the second electric vehicle, consensus component 214 can further direct the second electric vehicle to vacate the second charging patch to allow the first vehicle to enter the second charging patch. The second charging patch is located closer to the first electric vehicle than the first charging patch and the second charging patch does not have capacity to charge both the first electric vehicle and the second electric vehicle.

In an embodiment, various electronic vehicles can be associated with a priority level for scheduling and keeping electric charging time slots. For example, a stationary charging station or a charging patch may allow highest priority electric vehicles an early opportunity to schedule electric charging time slots. For another example, a stationary charging station or a charging patch may designate certain time slots as only being available to highest priority electric vehicles. In an embodiment, an electric vehicle passenger with a high level of range anxiety can purchase a priority scheduling designation for the electric vehicle. In an embodiment, an electric vehicle passenger with a moderate level of range anxiety can purchase a moderate priority scheduling designation for the electric vehicle. In an embodiment, an electric vehicle passenger with a low level of range anxiety can purchase or accept a standard priority scheduling designation for the electric vehicle.

The system 200 comprises a speed component 216. The speed component 216 can control a speed of the electric vehicle to cause the electric vehicle to arrive at the charging patch according to the electric charging slot. In an embodiment, the speed component 216 can control a speed of the electric vehicle to cause the electric vehicle to arrive at a stationary charging station according to the electric charging time slot. In an embodiment, the speed component 216 can recommend a speed to the electric vehicle to cause the electric vehicle to arrive at the charging station or charging lane according to the electric charging slot.

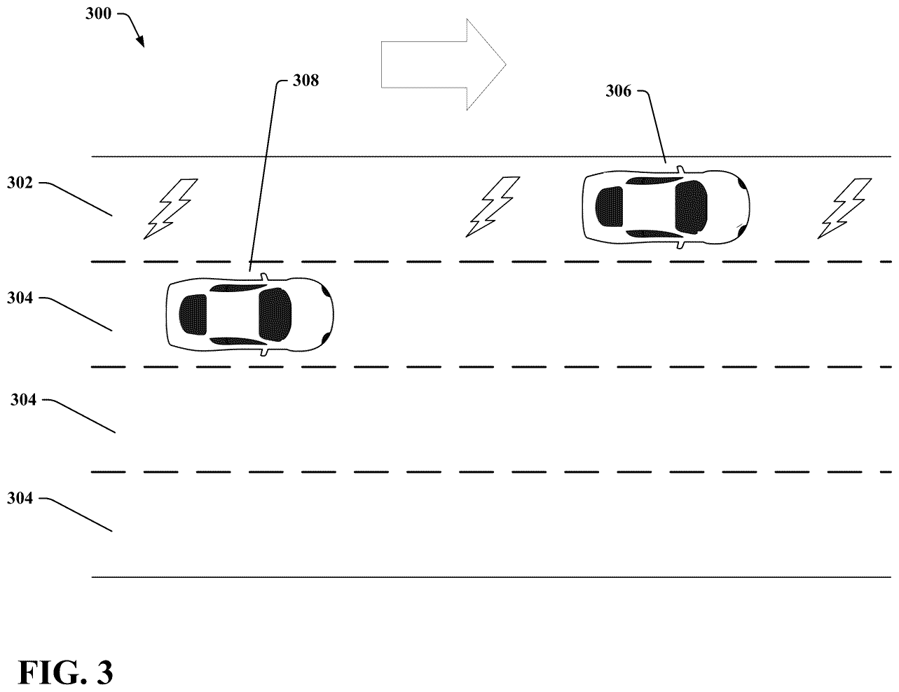

FIG. 3 illustrates an example, non-limiting system 300 that facilitates scheduling charging for electric vehicles, in accordance with one or more embodiments described herein. Repetitive description of like elements and/or processes employed in respective embodiments is omitted for sake of brevity. As indicated previously, description relative to an embodiment of FIGS. 1-2 can be applicable to an embodiment of FIG. 3. Likewise, description relative to an embodiment of FIG. 3 can be applicable to an embodiment of FIGS. 1-2.

The system 300 illustrates a roadway comprising electric charging lane 302 and regular lanes 304. An electric vehicle 306 is driving in the electric charging lane 302. Vehicle 308 is driving in one of the regular lanes 304. The charging lane 302 has a surface capable of charging a battery of electric vehicle 306 while electric vehicle 306 is in motion. The surface of charging lane 302 can comprise a wireless electric vehicle charging apparatus. Regular lanes 304 are not capable of charging an electric vehicle.

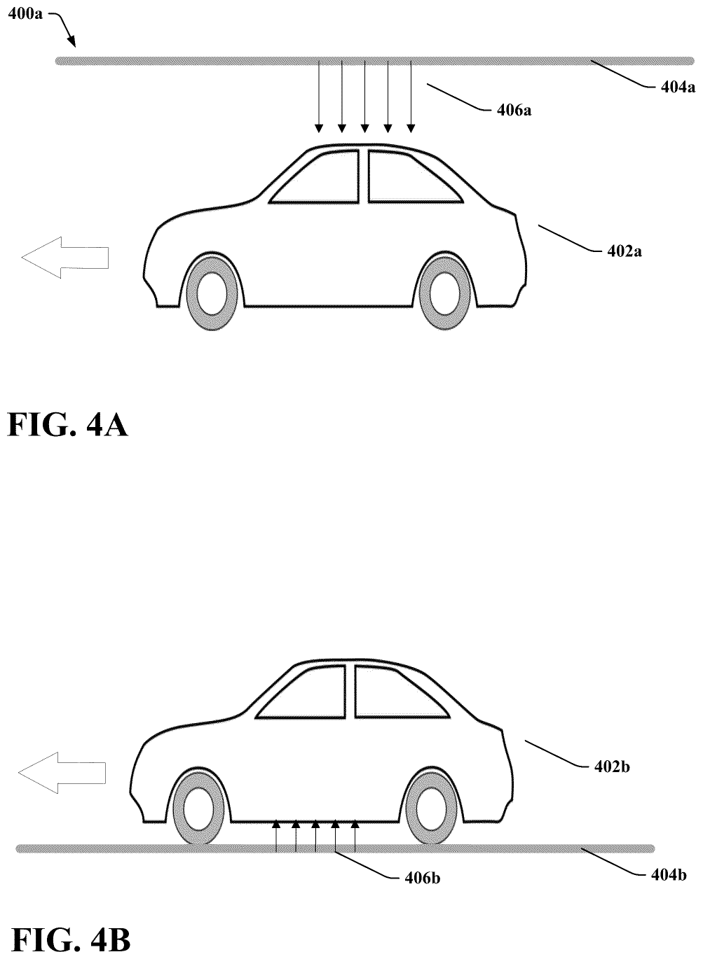

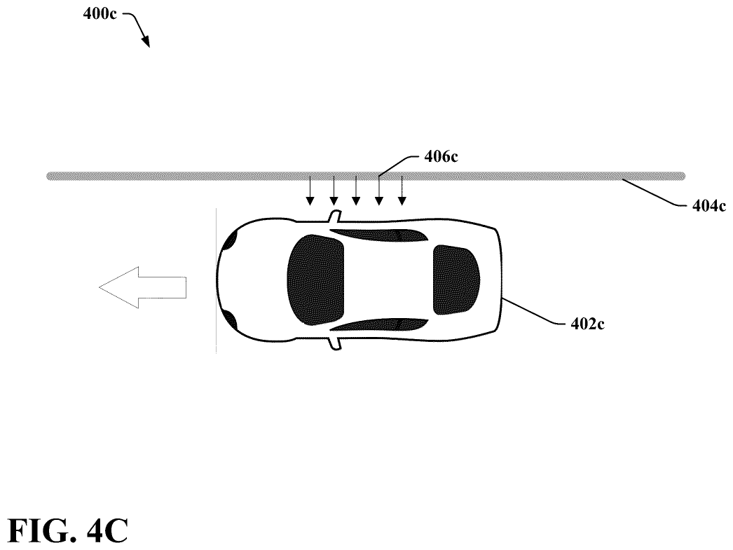

FIG. 4A illustrates an example, non-limiting system 400A that facilitates scheduling charging for electric vehicles, in accordance with one or more embodiments described herein. Repetitive description of like elements and/or processes employed in respective embodiments is omitted for sake of brevity. As indicated previously, description relative to an embodiment of FIGS. 1-3 can be applicable to an embodiment of FIG. 4A. Likewise, description relative to an embodiment of FIG. 4A can be applicable to an embodiment of FIGS. 1-3.

The system 400A illustrates an electric vehicle 402A that is in motion. Overhead charging rail 404A is capable of charging the electric vehicle 402A while it is in motion. Overhead charging rail 404A may charge a battery of an electric vehicle 402A using various techniques of dynamic power transfer as illustrated by arrows 406A. A “charging patch” as referred to herein can be an overhead charging apparatus as depicted in FIG. 4A.

FIG. 4B illustrates an example, non-limiting system 400B that facilitates scheduling charging for electric vehicles, in accordance with one or more embodiments described herein. Repetitive description of like elements and/or processes employed in respective embodiments is omitted for sake of brevity. As indicated previously, description relative to an embodiment of FIGS. 1-3 can be applicable to an embodiment of FIG. 4B. Likewise, description relative to an embodiment of FIG. 4B can be applicable to an embodiment of FIGS. 1-3.

The system 400B illustrates an electric vehicle 402B that is in motion. Underlaying charging rail 404B is capable of charging the electric vehicle 402B while it is in motion. Underlaying charging rail 404B may charge a battery of an electric vehicle 402A using various techniques of dynamic power transfer as illustrated by arrows 406B. A “charging patch” as referred to herein can be an underlaying charging apparatus as depicted in FIG. 4B.

FIG. 4C illustrates an example, non-limiting system 400C that facilitates scheduling charging for electric vehicles, in accordance with one or more embodiments described herein. Repetitive description of like elements and/or processes employed in respective embodiments is omitted for sake of brevity. As indicated previously, description relative to an embodiment of FIGS. 1-3 can be applicable to an embodiment of FIG. 4C. Likewise, description relative to an embodiment of FIG. 4C can be applicable to an embodiment of FIGS. 1-3.

The system 400C illustrates an electric vehicle 402C that is in motion. Side charging rail 404C is capable of charging the electric vehicle 402C while it is in motion. Side charging rail 404C may charge a battery of an electric vehicle 402C using various techniques of dynamic power transfer as illustrated by arrows 406C. A “charging patch” as referred to herein can be a side charging apparatus as depicted in FIG. 4C.

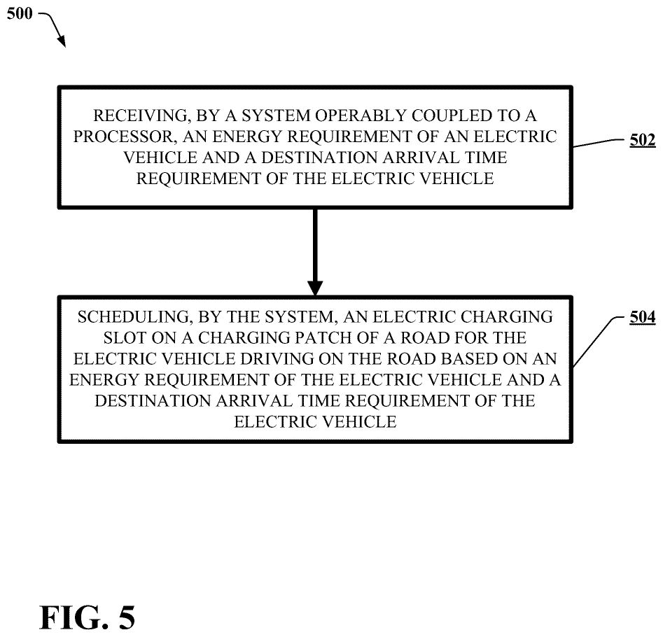

FIG. 5 illustrates a flow diagram of an example, non-limiting method 500 that can facilitate scheduling charging for electric vehicles, such as in the non-limiting system 100 of FIG. 1. While the non-limiting method 500 is described relative to the non-limiting system 100 of FIG. 1, the non-limiting method 500 can be applicable also to other systems described herein. Repetitive description of like elements and/or processes employed in respective embodiments is omitted for sake of brevity. At 502, the non-limiting method 500 can comprise receiving, by a system operably coupled to a processor (e.g., scheduler component 112), an energy requirement of an electric vehicle and a destination arrival time requirement of the electric vehicle. At 504, the non-limiting method 500 can comprise scheduling, by the system (e.g., scheduler component 112), an electric charging slot on a charging patch of a road for the electric vehicle driving on the road based on an energy requirement of the electric vehicle and a destination arrival time requirement of the electric vehicle.

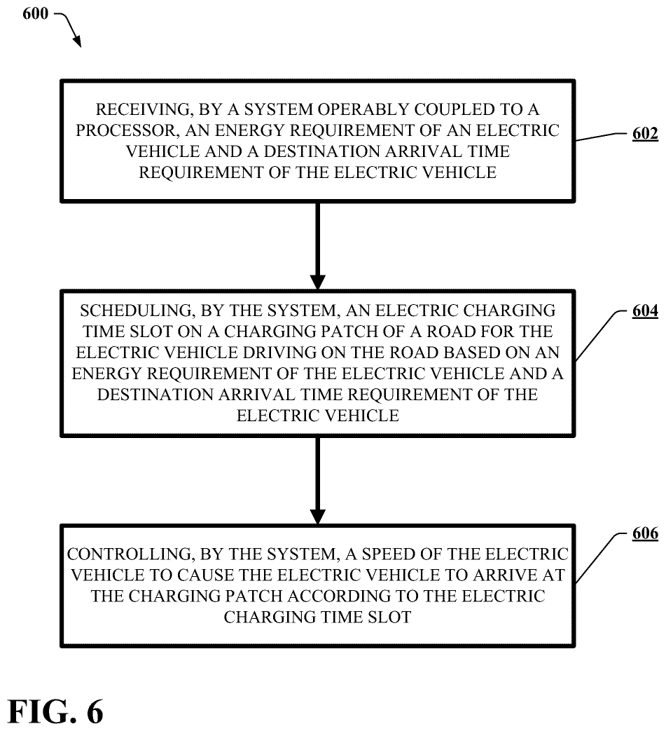

FIG. 6 illustrates a flow diagram of an example, non-limiting method 600 that can facilitate scheduling charging for electric vehicles, such as in the non-limiting system 200 of FIG. 2. While the non-limiting method 600 is described relative to the non-limiting system 200 of FIG. 2, the non-limiting method 600 can be applicable also to other systems described herein. Repetitive description of like elements and/or processes employed in respective embodiments is omitted for sake of brevity. At 602, the non-limiting method 600 can comprise receiving, by a system operably coupled to a processor (e.g., scheduler component 112), an energy requirement of an electric vehicle and a destination arrival time requirement of the electric vehicle. At 604, the non-limiting method 600 can comprise scheduling, by the system (e.g., scheduler component 112), an electric charging time slot on a charging patch of a road for the electric vehicle driving on the road based on an energy requirement of the electric vehicle and a destination arrival time requirement of the electric vehicle. At 606, the non-limiting method 600 can comprise controlling, by the system (e.g., speed component 216), a speed of the electric vehicle to cause the electric vehicle to arrive at the charging patch according to the electric charging time slot.

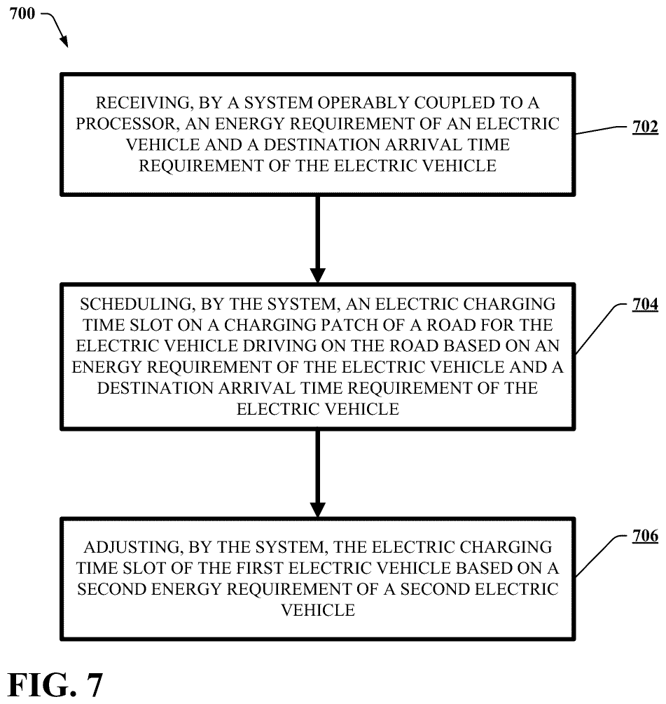

FIG. 7 illustrates a flow diagram of an example, non-limiting method 700 that can scheduling charging for electric vehicles, such as in the non-limiting system 200 of FIG. 2. While the non-limiting method 700 is described relative to the non-limiting system 200 of FIG. 2, the non-limiting method 700 can be applicable also to other systems described herein. Repetitive description of like elements and/or processes employed in respective embodiments is omitted for sake of brevity. At 702, the non-limiting method 700 can comprise receiving, by a system operably coupled to a processor (e.g., scheduler component 112), an energy requirement of an electric vehicle and a destination arrival time requirement of the electric vehicle. At 704, the non-limiting method 700 can comprise scheduling, by the system (e.g., scheduler component 112), an electric charging time slot on a charging patch of a road for the electric vehicle driving on the road based on an energy requirement of the electric vehicle and a destination arrival time requirement of the electric vehicle. At 706, the non-limiting method 700 can comprise adjusting, by the system (e.g., consensus component 214), the electric charging time slot of the first electric vehicle based on a second energy requirement of a second electric vehicle.

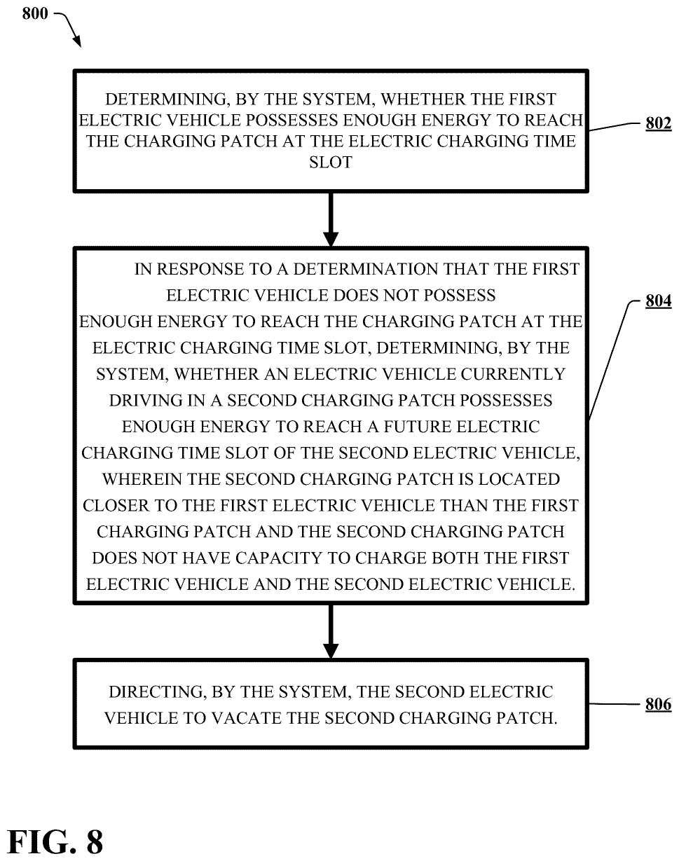

FIG. 8 illustrates a flow diagram of an example, non-limiting method 800 that can facilitate scheduling charging for electric vehicles, such as in the non-limiting system 200 of FIG. 2. While the non-limiting method 800 is described relative to the non-limiting system 200 of FIG. 2, the non-limiting method 800 can be applicable also to other systems described herein. Repetitive description of like elements and/or processes employed in respective embodiments is omitted for sake of brevity. At 802, the non-limiting method 800 can comprise determining, by the system (e.g., consensus component 214), whether the first electric vehicle possesses enough energy to reach the charging patch at the electric charging time slot. At 804, the non-limiting method 800 can comprise determining, in response to a determination that the first electric vehicle does not possess enough energy to reach the charging patch at the electric charging time slot, by the system (e.g., consensus component 214), whether an electric vehicle currently driving in a second charging patch possesses enough energy to reach a future electric charging time slot of the second electric vehicle, wherein the second charging patch is located closer to the first electric vehicle than the first charging patch and the second charging patch does not have capacity to charge both the first electric vehicle and the second electric vehicle. At 806, the non-limiting method 800 can comprise directing, by the system (e.g., consensus component 214), the second electric vehicle to vacate the second charging patch.

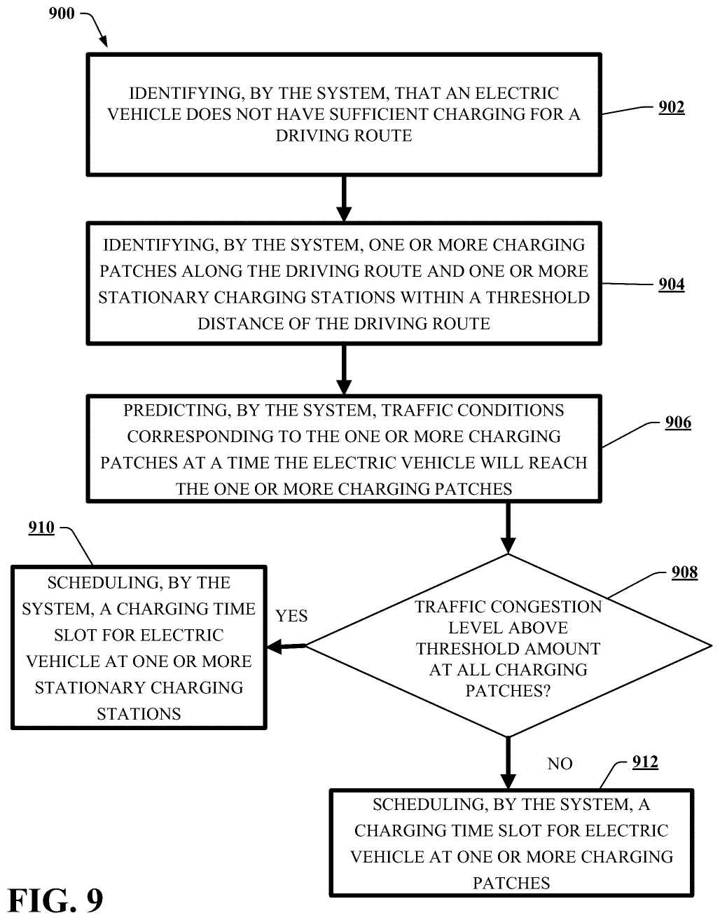

FIG. 9 illustrates a flow diagram of an example, non-limiting method 900 that can facilitate scheduling charging for electric vehicles, such as in the non-limiting system 200 of FIG. 2. While the non-limiting method 900 is described relative to the non-limiting system 200 of FIG. 2, the non-limiting method 900 can be applicable also to other systems described herein. Repetitive description of like elements and/or processes employed in respective embodiments is omitted for sake of brevity. At 902, the non-limiting method 900 can comprise identifying, by the system (e.g., navigation component 110), that an electric vehicle does not have sufficient charging for a driving route. At 904, the non-limiting method 900 can comprise identifying, by the system (e.g., navigation component 110), one or more charging patches along the driving route and one or more stationary charging stations within a threshold distance of the driving route. For example, the system can identify the charging patches and stationary charging patches along or within a threshold distance of the driving route that are located such that the electric vehicle has sufficient charge to reach the identified charging patches and stationary charging stations. At 906, the non-limiting method 900 can comprise predicting, by the system (e.g., navigation component 110), traffic conditions corresponding to the one or more charging patches at a time the electric vehicle will reach the one or more charging patches. At 908, the non-limiting method 900 can comprise determining, by the system (e.g., navigation component 110), whether the traffic congestion level is above a threshold amount at all identified charging patches. If yes, at 910, the non-limiting method 900 can comprise scheduling, by the system (e.g., scheduler component 112), a charging time slot for electric vehicle at one or more stationary charging stations. If no, at 912, the non-limiting method 900 can comprise scheduling, by the system (e.g., scheduler component 112), a charging time slot for electric vehicle at one or more charging patches.

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as scheduling code (block) 1045. In addition to block 1045, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1045, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1045 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in block 1045 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 901 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on the user's computer, partly on the user's computer, as a stand-alone software package, partly on the user's computer or partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described herein with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality, and operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function(s). In one or more alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that the one or more embodiments herein also can be implemented in combination with other program modules. Generally, program modules include routines, programs, components, data structures or the like that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics or the like. The illustrated aspects can also be practiced in distributed computing environments in which tasks are performed by remote processing devices that are linked through a communications network. However, some, if not all aspects of the one or more embodiments can be practiced on stand-alone computers. In a distributed computing environment, program modules can be located in both local and remote memory storage devices.

As used in this application, the terms “component,” “system,” “platform,” “interface,” or the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the one or more embodiments, but one of ordinary skill in the art can recognize that many further combinations and permutations of the one or more embodiments are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the one or more embodiments provided herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
a memory that stores computer executable components; and
a processor that executes the computer executable components stored in the memory, wherein the computer executable components comprise:
a scheduler component that schedules an electric charging time slot for a charging patch of a road for an electric vehicle based on an energy requirement of the electric vehicle and a destination arrival time requirement of the electric vehicle.

2. The system of claim 1, wherein the scheduler component schedules the electric charging time slot based on a charging capacity of the charging patch.

3. The system of claim 1, wherein the scheduler component schedules the electric charging time slot based on a level of range anxiety of a passenger of the electric vehicle.

4. The system of claim 1, wherein the scheduler component schedules the electric charging time slot based on an availability of electric charging slots of parking charging locations within a threshold distance of a driving route of the electric vehicle.

5. The system of claim 1, wherein the computer executable components further comprise:
a speed component that controls a speed of the electric vehicle to cause the electric vehicle to arrive at the charging patch according to the electric charging time slot.

6. The system of claim 1, wherein the electric vehicle is a first electric vehicle and the computer executable components further comprise:
a consensus component that adjusts the electric charging time slot of the first electric vehicle based on a second energy requirement of a second electric vehicle.

7. The system of claim 6, wherein the consensus component switches the electric charging time slot of the first electric vehicle with a second electric charging time slot of the second electric vehicle.

8. The system of claim 6, wherein the charging patch is a first charging patch, and the consensus component further:
determines whether the first electric vehicle possesses a minimum amount of energy required to reach the charging patch at the electric charging time slot; and
in response to a determination that the first electric vehicle does not possess the minimum amount of energy required to reach the charging patch at the electric charging time slot, determines whether the second electric vehicle currently driving in a second charging patch possesses a second minimum amount of energy required to reach a future electric charging time slot of the second electric vehicle, wherein the second charging patch is located closer to the first electric vehicle than the first charging patch and the second charging patch does not have capacity to charge both the first electric vehicle and the second electric vehicle.

9. The system of claim 8, wherein the consensus component further directs the second electric vehicle to vacate the second charging patch.

10. A computer-implemented method, comprising:
receiving, by a system operably coupled to a processor, an energy requirement of an electric vehicle and a destination arrival time requirement of the electric vehicle; and
scheduling, by the system, an electric charging time slot for a charging patch of a road for the electric vehicle driving on the road based on the energy requirement of the electric vehicle and the destination arrival time requirement of the electric vehicle.

11. The computer-implemented method of claim 10, wherein the scheduling is based on a level of range anxiety of a passenger of the electric vehicle.

12. The computer-implemented method of claim 10, further comprising:
controlling, by the system, a speed of the electric vehicle to cause the electric vehicle to arrive at the charging patch according to the electric charging time slot.

13. The computer-implemented method of claim 10, wherein the electric vehicle is a first electric vehicle and further comprising:
adjusting, by the system, the electric charging time slot of the first electric vehicle based on a second energy requirement of a second electric vehicle.

14. The computer-implemented method of claim 13, wherein the charging patch is a first charging patch, further comprising:
determining, by the system, whether the first electric vehicle possesses a minimum amount of energy required to reach the charging patch at the electric charging time slot; and
responsive to determining that the first electric vehicle does not possess the minimum amount of energy required to reach the charging patch at the electric charging time slot, determining, by the system, whether the second electric vehicle currently driving in a second charging patch possesses a second minimum amount of energy required to reach a future electric charging time slot of the second electric vehicle, wherein the second charging patch is located closer to the first electric vehicle than the first charging patch and the second charging patch does not have capacity to charge both the first electric vehicle and the second electric vehicle.

15. The computer-implemented method of claim 14, further comprising:
directing, by the system, the second electric vehicle to vacate the second charging patch.

16. A computer program product facilitating electric charging scheduling for electric vehicles, the computer program product comprising a computer readable storage medium having program instructions embodied therewith, the program instructions executable by a processor to cause the processor to:
receive an energy requirement of an electric vehicle and a destination arrival time requirement of the electric vehicle; and
schedule an electric charging time slot for a charging patch of a road for the electric vehicle driving on the road based on the energy requirement of the electric vehicle and the destination arrival time requirement of the electric vehicle.

17. The computer program product of claim 16, wherein the program instructions are further executable by the processor to cause the processor to:
control a speed of the electric vehicle to cause the electric vehicle to arrive at the charging patch according to the electric charging time slot.

18. The computer program product of claim 16, wherein the electric vehicle is a first electric vehicle and wherein the program instructions are further executable by the processor to cause the processor to:
adjust the electric charging time slot of the first electric vehicle based on a second energy requirement of a second electric vehicle.

19. The computer program product of claim 18, wherein the charging patch is a first charging patch and wherein the program instructions are further executable by the processor to cause the processor to:
determine whether the first electric vehicle possesses a minimum amount of energy required to reach the charging patch at the electric charging time slot; and
in response to a determination that the first electric vehicle does not possess the minimum amount of energy required to reach the charging patch at the electric charging time slot, determine whether the second electric vehicle currently driving in a second charging patch possesses a second minimum amount of energy required to reach a future electric charging time slot of the second electric vehicle, wherein the second charging patch is located closer to the first electric vehicle than the first charging patch and the second charging patch does not have capacity to charge both the first electric vehicle and the second electric vehicle.

20. The computer program product of claim 19, wherein the program instructions are further executable by the processor to cause the processor to:
direct the second electric vehicle to vacate the second charging patch.
